(19) United States
(12) Patent Application Publication
(10) Pub. No.: US 2021/0180272 A1
(43) Pub. Date: Jun. 17, 2021

(54) CONCRETE RESTORATION AND ORNAMENTATION METHOD AND APPARATUS

(71) Applicant: Don Velazquez, San Diego, CA (US)

(72) Inventor: Don Velazquez, San Diego, CA (US)

(21) Appl. No.: 17/184,556

(22) Filed: Feb. 24, 2021

Related U.S. Application Data
(63) Continuation-in-part of application No. 15/243,794, filed on Aug. 22, 2016, now abandoned.
(60) Provisional application No. 62/208,469, filed on Aug. 21, 2015.

(51) Int. Cl. E01C 23/088; B24B 7/18; B28D 1/14; B28D 1/30

(52) U.S. Cl. CPC E01C 23/088; B28D 1/30; B28D 1/146; B24B 7/18

(57) ABSTRACT

A method and apparatus is provided to rehabilitate and beautify cracked concrete surfaces by adding channels that look like the cracks to the surface.

### PRIORITY INFORMATION

This Application claims priority to U.S. Provisional Application No. 62/208,469 filed 21 Aug. 2015. This application is also a continuation in part from U.S. Patent Application No. 2017/0051522 filed 22 Aug. 2016, and claims priority thereto. This application is also a continuation in part from U.S. patent application Ser No. 15/802,184, filed 2 Nov. 2017, and claims priority thereto.

### FIELD OF THE INVENTION

The present subject matter relates to ornamentation, repair, and restoration of bodies comprised of concrete, stone, tile and other surfaces. More particularly it relates to a method and apparatus for imparting channels or scoring surfaces of bodies to form designs therein to decorate new and existing surfaces and to rehabilitate existing cracked surfaces to render them aesthetic to the human eye.

### BACKGROUND

Concrete is used in the construction of bodies such as walls, driveways, patios, swimming pools, fountains, walkways, highways, and tilt-up construction. Concrete bodies are subject to cracking, as for example due to settling of ground beneath the bodies. Such cracks may have a depth of inches. Further, such cracks are unsightly and are hazardous to people walking on the concrete. Simply filling such cracks by patching leaves the appearance of a patched surface with seams of highly visible material that acts as advertisement that a crack was present and was patched.

Overlay repairs intended to emulate set-stones may not provide a flat surface, and they may provide the same chance of tripping, breaking heels, and stubbing toes that occurs with many natural stone surfaces. Ornamental restoration may be done using stamp overlay products intended to place a layer to cover repaired or previously cracked surfaces. The objective of prior art methods, which is often unsuccessful, is to eliminate cracks or patterns. However, such prior art methods do not include the integration or use of existing cracks as a portion of the ornamentation while creating the appearance of patterns in the body or surface. Further, such prior art methods and devices, do not allow for the pre-planning of a decorative surface using existing cracks as part of an overall design imparted to a surface.

Many conditions can lead to exacerbation of concrete faults. Weeds or more sturdy vegetation tend to begin growing in cracks. The roots become well entrenched. This gives the property a dilapidated look. Growth of the vegetation tends to induce further cracks. In northern climates, snow will melt into cracks, leaving water in the crack. When the temperature drops, the water expands as it turns into ice, further stressing cracks. As a result, further cracking results.

Many products exist for use in crack repair and concrete resurfacing. These products include Super-Krete.®and Quik-Crete.®. concrete mixes. Such products are intended to provide for mechanical integrity of a concrete body. They are not intended for making the repaired surface look like anything other than a repaired surface. Overlay products are intended for ornamentation and can be stamped or textured. These products can be applied in varying thickness from about 1/16″ to ½″ or thicker, with ¼″ being common.

Prior art methods are not focused on creating ornamentation in combination with repair and restoration to render a repaired surface to appear as planned or original. In many applications, it is highly undesirable to provide the appearance of a repaired surface which while appearing repaired, also is viewable as decorative and quite possibly original. For example, a very important quality of a house for sale is “curb appeal,” i.e., how attractive the property looks as a sales prospect drives up. Flaws in the appearance of a driveway tend to decrease the price and the value of the property. Complete replacement of the driveway, as a practical matter, is not cost justified.

Prior art techniques include creating the appearance of grout-like joints or actual grout joints. Workers may be bent over during certain operations, which can cause orthopedic problems as well as exhaustion and dehydration. There are power tools that allow a worker to stand. However, certain finishing operations still require a worker to bend over to work at ground level. Techniques generally require tools that operate at high speed and that provide a greater risk of injury to workers who are placed near the tools by this bent or stooped work requirement. Further, such risk causes higher insurance costs for contractors. However, prior art techniques which teach repair or decoration of cementitious and stone surfaces and the like, each have particular shortcomings.

United States Published Patent Application No. 20140272250 discloses a slab of building material in which a fill component is placed in a void. The slab may comprise a first body that is adhered to another body. The bodies may be comprised of natural stone, wood, or other material. This disclosure is directed toward making a new slab out of broken pieces of other slabs. It is not a method or device for repair cracks in a cementitious surface nor is it is not directed to repair and remediation in a manner rendering the slab aesthetically pleasing.

United States Published Patent Application No. 20150191398 discloses a method for forming patterns on a surface of a hydraulic binder composition with a stencil. After setting of the surface and removal of the stencil, a friable delayed concrete layer in the pattern of the stencil remains. The deposited surface is later washed away to leave a pattern in concrete. Although this method provides for forming a pattern, this method does not allow for remediation of the unfinished appearance of repaired or broken surfaces. The pattern is not coordinated with preexisting lines, e.g., cracks, in a surface and the secondary layer imparted to the original is prone to chipping or delaminating.

United States Published Patent Application No. 20140248460 discloses a method for concrete crack repair in which a saw cut is made next to an open shrinkage crack. Expansive mortar is placed in the saw cut. As the mortar sets, it expands. The expanded mortar shifts the saw cut toward the shrinkage crack to make the crack narrower. However, the crack is not treated and does not become part of a remediation solution.

U.S. Pat. No. 5,310,780 discloses compositions for staining concrete. These compositions are useful in coloring different bounded areas within a pattern. However, a process for making a pattern is not disclosed. United States Published Patent Application No. 20040151950 discloses a method in which stains are applied to different sections of a concrete test slab however no means for forming a decorative pattern is disclosed.

### SUMMARY

As such, there exists an unmet need, for a system for a method and apparatus for the repair of cracked surfaces of concrete, stone, tile and other similar bodies. Such a system should employ methods for creating tooled channels in the bodies and to employ the channels with pre-existing cracks/fissures to form a final viewable surface that disguises the pre-existing cracks/fissures so that they appear as part of a planned pattern. Such a system may employ a device that creates channels in a surface being repaired, wherein a user of the device is either upright and at a safe distance from the tool, or where the device is robotically controlled. A robotically controlled device may employ electronic navigation within defined borders of an area to be repaired to impart a pattern of channels into a surface being repaired. Still further, such a device may be easily operated either manually, or by remote control, to thereby allow widespread use by both homeowners and contractors to impart designs into both new surfaces and old surfaces being repaired.

An object of the present invention is the provision of a system that enables the etching or engraving of surfaces of concrete, tile stone, and similar bodies to impart indicia in the form of patterns, designs and images thereto.

Another object of the invention to create channels in bodies, and to use the channels are with pre-existing cracks/fissures in the bodies as part of a finished pattern or design.

In accordance with other aspects of the present invention, a method and apparatus are provided to rehabilitate and beautify new and cracked concrete, stone, and tile surfaces, in a cost-effective and sustainable way. An apparatus enabling the method herein includes a tool and tool accessories for forming channels in the surface, such as by chipping, drilling, routing, scoring, etching, or cutting using tool . Such tools as herein defined include, but are not limited to: drills, rotary hammers, impact drills, jack hammers, grinders, oscillating tools, vibrators, routers, saws, granite cutters, concrete engraving tools and more. Selection of a tool may be made in accordance with a desired appearance of a finished product.

A tool may be supported and may be movable. A movable tool can have wheels, glides, or casters to allow movement. A tool may be self-propelled and autonomous and move according to an electronic map held in computer memory, or a handle may be supported to the tool at a selectable height to enable a worker to stand up straight while operating the tool.

In use, a cracked surface is evaluated and a desired remediation is performed using a tool manually, or controlling the tool autonomously. Before remediation electronic imaging of a surface and its perimeter area may be performed and/or a drawing may be generated to assist in the remediation. Remediation may form a pattern into the surface to be repaired by including pre-existing cracks/fissures as part of the pattern.

A pattern may include channels that are formed in the concrete in accordance with a guide pattern determined either using a manual or self-propelled autonomous tool that follows the guide pattern to impart them. Channels may vary in depth, width, and length in accordance with a desired pattern.

Bodies the channels of the system herein can be applied to include, but are not limited to: driveways, sidewalks, walkways, patios, sidewalls, floors, entries, and foyers. The system herein allows such repairs to be accomplished in a more cost-effective and sustainable way, because rather than jack hammering and removing the surface, existing cracks/fissures and imperfections may be employed as part of a finished pattern, image, or design, or they may be employed along with a random, natural-appearing pattern that allows a user to ‘hide the problem in plain sight’ and turn defects into art.

Channels of the present invention may vary in depth, width and length, depending on the desired pattern to be imparted to the surface, as well as the budget for such surfacing. Using either a manual or automated tool or method users can beautify horizontal or vertical surfaces by incorporating any design of their choosing into the surface. A self-propelled system for imparting channels into a surface may accomplish such in a matter of hours or less by using onboard computer memory and software to steer a tool and if needed to translate the tool. Tools that operate at relatively low or high speed may be employed.

In one embodiment, the present invention comprises a method of rehabilitating and beautifying a surface having one or more pre-existing crack in the surface by adding a plurality of channels to the surface, the method comprising the steps of: (a) supporting a tool over the surface; and (b) directing the tool against the surface to create the plurality of channels in the surface, wherein the plurality of channels are each defined by two opposite ends and a length, wherein the length is longer than a measured straight-line distance between the two opposite ends. In one embodiment, the length is at least 5% longer than a measured straight-line distance between the two ends. In one embodiment, at least one of the plurality of channels is non-linear over its entire length. In one embodiment, the one or more pre-existing crack and the one or more plurality of channels define a border of one or more shape. In one embodiment, at least two shapes share a portion of the same border. In one embodiment, at least one of the plurality of channels extends from at least one of the one or more crack at angle that not 90 degrees. In one embodiment, the plurality of channels are defined by a maximum depth, and wherein the maximum depth is one inch or less. In one embodiment, the plurality of channels is created to function as a control joint. In one embodiment, the step of directing the tool comprises repeatedly directing the tool vertically up and down against the surface while also directing the tool horizontally over the surface. In one embodiment, the tool is selected from the group consisting of an impact drill, a jack hammer, and a rotary hammer. In one embodiment, the invention further comprises a step of positioning a guide onto the surface. In one embodiment, the present invention further comprises the steps of: determining a position of the one or more pre-existing crack; and directing the tool based on the step of determining the position. In one embodiment, the guide is comprised of one or more line. In one embodiment, the one or more line is formed by a projected image. In one embodiment, the step of directing comprises directing the tool along the one or more line. In one embodiment, the present invention further comprises the steps of: detecting a position of the guide; generating an electronic signal based on the position of the guide; and directing the tool along the surface according to the electronic signal. In one embodiment, the electronic signal is processed by a computer prior to the step of directing the tool along the surface. In one embodiment, the present invention further comprises the steps of providing a motorized platform and using the motorized platform to direct the tool along the surface. In one embodiment, the concrete body comprises a driveway, patio, sidewalk, wall, walkway, floor, and/or a foyer. In one embodiment, the tool comprises one or more of: a drill, rotary hammer, impact drill, jack hammer, grinder, vibrator, router, saw, granite cutter, and engraver. In one embodiment, the present invention further comprises the step of applying a material to the surface to fill the plurality of channels and the one or more pre-existing crack with the material. In one embodiment, the body is selected from the group consisting of concrete, stone, and tile.

### BRIEF DESCRIPTION OF THE DRAWINGS

FIG. 1 is a detailed perspective view of a crack/fissure in a body, such as a concrete driveway.

FIG. 2 is a perspective view of a cracked driveway.

FIG. 3 is a perspective view of channels formed in combination with pre-existing cracks/fissure.

FIG. 4 shows a depiction of a surface being leveled and repaired with filler.

FIG. 5 shows a crack/fissure which has been filled and ready for overlay.

FIG. 6 depicts a sectional view showing a filled crack/fissure and overlay material.

FIG. 7 depicts a distal end of an engraving tool forming a channel above a crack/fissure in a surface.

FIG. 8 depicts a mount used herein with a tool.

FIG. 9 shows the mount of FIG. 8 with a biasing component.

FIG. 10 shows a manually operated tool used in combination with a mount.

FIG. 11 shows a graphic plot or depiction of the perimeter of an existing surface with existing cracks/fissures.

FIG. 12 depicts channels which are formed used by a powered tool with electronic memory, to impart channels to a surface.

FIG. 13 shows a powered tool which comprises a tool accessory attachment in operative engagement with a surface to impart channels.

FIG. 14 depicts a distal end of a tool accessory forming a channel in an uncracked portion of a surface.

FIG. 15 depicts the lengths and straight-line distances between ends A-B and C-D of sidewalls of a channel.

### DETAILED DESCRIPTION

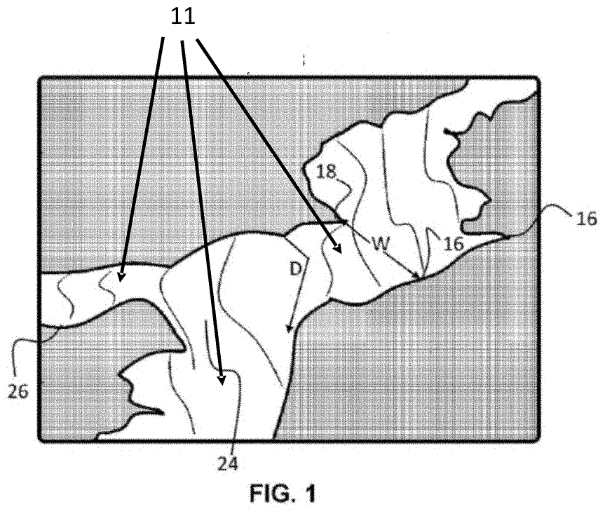

FIG. 1 depicts a top surface view of a portion of a body 8 comprised of a plurality of pre-existing cracks/fissures 11. Each crack/fissure is defined by sidewalls 16 and 18 between which a width W may be measured at opposing points along a length of the crack/fissure. Each crack/fissure also comprises a depth D that may be measured vertically at points along the length of the crack/fissure from a bottom of the crack to the surface. Sidewall surfaces of cracks/fissure are typically irregular rather than flat and may be disposed at any one of a number of angles with respect to a vertical axis. An intersection or meeting of the surface of the body and the tops of the sidewall surfaces defines rough and irregular corners 26.

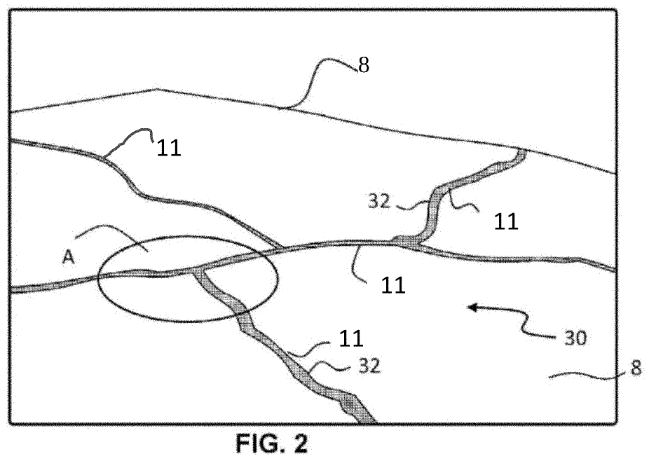

FIG. 2 is a perspective view of a surface of a body 8 (e.g., a concrete driveway) comprised of a plurality of cracks/fissures 11. Cracks/fissures in concrete may be caused by the settling of ground beneath, changes in temperature, excessive loads, or any number of other causes known in the art. In some embodiments, cracks/fissures may be filled with patching concrete 32. However, even when patched concrete surfaces will still appear to the naked eye that the concrete was cracked in the past and a repair has been attempted.

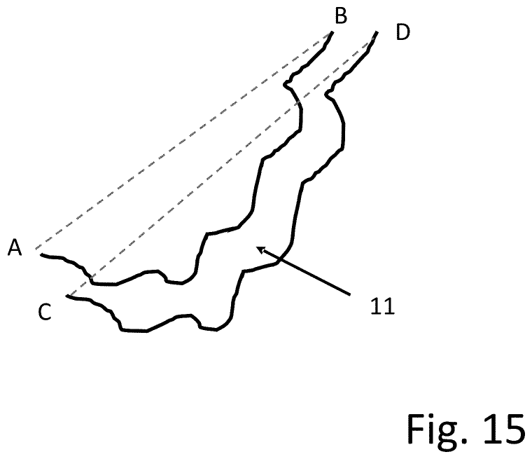

FIG. 3 is a perspective view of a surface of a body 8 that has been repaired using methods and devices described further herein. In one embodiment, a plurality of channels 29 are configured to create a pattern that incorporates pre-existing cracks/fissures 11 in an aesthetically pleasing and ornamental manner. In one embodiment, a plurality of channels 29 are incorporated with pre-existing cracks/fissures 11 and configured to appear as a plurality of interlocking set stones. Channels may extend from one or more pre-existing crack/fissures, or from other channels. In embodiments, channels may be formed to comprise any geometry and shape, including, but not limited to: curved, jagged, linear, and/or non-linear geometries and shapes. Channels may comprise a length L and a depth D. The depth of a channel is not necessarily constant along the length of the channel, does not necessarily extend all the way through a concrete surface, and does not necessarily need to be the same depth as that of any particular pre-existing crack/fissures. In some embodiments, a maximum depth of a channel, as measured along its length, is 0.1 inch or less, 1 inch or less, or 6 inches or less. In one embodiment, the length L of a channel 11 is defined by measuring the distance along a corner and between the ends A-B or C-D of a of sidewall of a channel (see FIG. 15). Thus, in the above embodiment, for a channel that is at least partially non-linear, length L will be longer than the straight-line distance (dashed lines in FIG. 15) between A-B or C-D. In one embodiment, the length L of a channel 11 is defined by taking the average of the distance measured along the corners and between the ends A-B and C-D of each of sidewall of the channel (see FIG. 15). Thus, in the above embodiment, for a channel that is at least partially non-linear, length L will be longer than the average of the straight-line distance (dashed lines in FIG. 15) between each of the A-B and C-D. In some embodiments, the length L is 1 inch or less, 10 inches or less, 100 inches or less, or 1000 inches or less. In other embodiments, the length L may be as needed to create a desired shape or pattern. In some embodiments, length L is at least 1% longer, 5% longer, 10% longer, 25% longer, or 50% longer than the distance between ends A-B or C-D. In some embodiments, length L is at least 1% longer, 5% longer, 10% longer, 25% longer, or 50% longer than the average of the distance between ends A-B and C-D. In one embodiment, a channel may be formed such that one end of the channel extends from a sidewall of a crack/fissure and an opposite end of the channel terminates at a sidewall of another channel. In one embodiment, a channel may be formed such that one end of the channel extends from a sidewall of a crack/fissure and an opposite end terminates at a sidewall of the same or another crack/fissure. In one embodiment, a channel may be formed such that one end of the channel extends from a sidewall of a crack/fissure and such that an opposite end of the channel does not terminate at a sidewall of another channel, or the same or another crack/fissure. Channels may be formed such that they angularly extend from and/or terminate at pre-existing cracks/fissures or other channels. In embodiments, a channel may be formed such that it's length extends from and/or terminates along a length of a pre-existing crack/fissure at an angle other than 90 degrees as measured relative to the length of the crack/fissure at the extension or termination point of the channel. In one embodiment a channel may be formed such that it's length extends from and/or terminates along a length of a pre-existing crack/fissure at an angle of 90 degrees as measured relative to the length of the crack/fissure at the extension or termination point of the channel. In embodiments, a channel may be formed such that its length extends from and/or terminates along a length of a pre-existing crack/fissure at an angle of between 0 degrees and 90 degrees relative to the length of the crack/fissure at the extension or termination point of the channel. In one embodiment, one or more pre-existing crack and one or more channel define a border of one or more shape. In one embodiment, at least two shapes share a portion of the same border. In one embodiment, is configured to appear visually as a set stone. In one embodiment, one or more channels are added to a previously cracked concrete body to act as control joints, where control joints are known in the art to be used to prevent any further cracking in a concrete body and/or to direct any further cracking in a concrete body along the added channel(s). In some embodiments, channels are formed as control joints with an average depth that is deeper than an average depth of an otherwise applied pattern of channels. In some embodiments, channels are formed as control joints with a depth that extends all the way through a concrete body. In some embodiments, channels that are control joints are formed to be one or more of the channels of a pattern.

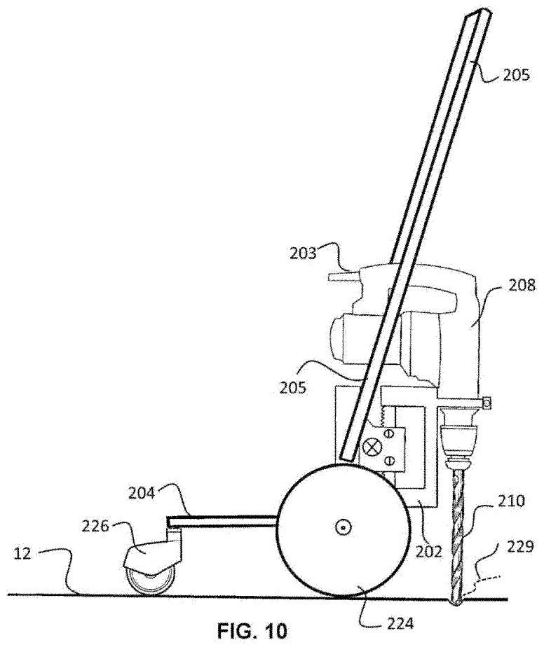

In a method herein employing a tool shown in FIG. 10, a channel 229 may be formed in a surface 12 without and/or with a guide. When a guide is used, the guide may be used to provide a path for a user and/or a computer to follow with the tool. In one embodiment, a guide may comprise lines drawn or otherwise temporarily formed, such as with tape, onto the surface. Faintly depicted or inscribed lines may be sufficient to allow further process steps using the manual mode of the method herein. If more precision is desired in forming channels, a grid pattern may be determined and included in a guide map to allow an installer to determine and manually mark significant points needed to create the channels.

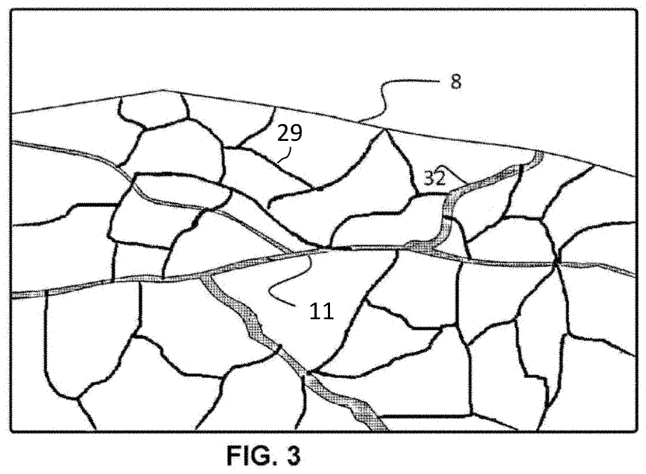

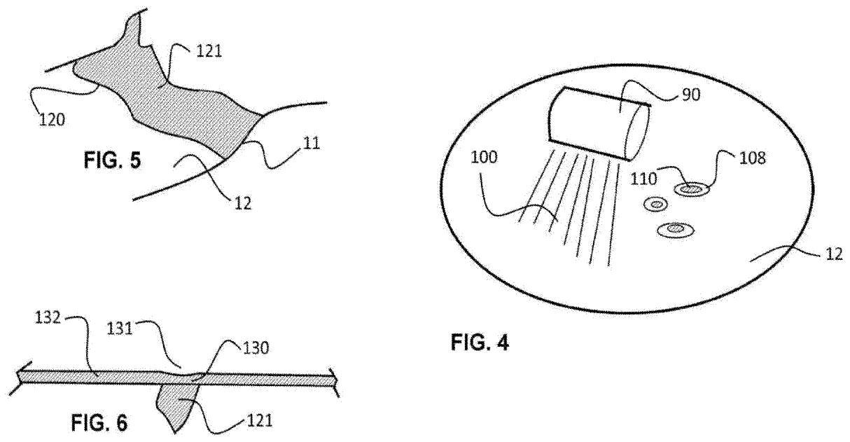

FIGS. 4 and 5 are each a perspective view of a small portion of a surface 12. In some cases, prior or after formation of channels, surface 12 may be prepared according to the following steps. As seen in FIG. 4, in a first step, the surface 12 may be leveled. This may be accomplished by scarifying the surface using a tool 90 to produce a scarified area 100. Alternatively or additionally, patches material 110 may be applied to holes 108. A next step may comprises further preparing the surface 12 for an overlay of material if such is to be employed to cover both pre-existing cracks/fissures, and/or to channels. Further preparation may include such application of cleaning liquids or primer.

Shown in FIG. 5 cracks/fissures 11 are filled and forms 120 may be placed in the cracks/fissures to project slightly above the top surface of the cracks to mark their positions. Filler material 121 may be applied to fill the volume in each crack/fissure. Filler material may be cement, polymeric material, or other filler suitable to the task. As seen in FIG. 6, a thin layer of overlay material 132 may be applied to the entire surface.

Shown in FIG. 6 is a typical cross-sectional elevation of application of an overlay material 130 applied to a surface 8. Overlay material 130 may be applied to form an overlay 132.

Overlay material 130 may be colored. Overlay material 130 may comprise concrete or a concrete composition, or can comprise a polymeric surface material. Different overlay compositions may be used to accommodate climate conditions, expected load, and expected wear. A nominal range of thickness of the overlay 132 is 1/16 to ¼ inch. Different thicknesses may be required for other compositions. The overlay material preferably has a light color in order to facilitate application of other colors. The overlay material 130 may be stained and sealed. Various concrete stains could be used. In the example of a driveway, sealing may extend surface life.

High gloss sealers may be slippery. Acrylic sealers are generally preferred. The acrylic sealers may be blended with epoxies, polyurethane, or silicones to improve performance, durability, and water resistance. Other types of topical sealers for driveways are polyurethane, epoxies, and penetrating resins. Generally, epoxy or polyurethane sealers cost considerably more than acrylics and they tend to be higher build, and thus more slippery. They also don't allow for moisture vapor to move out of the concrete. Sealers used on exterior concrete allow the passage of both air and moisture. Penetrating sealers are made of specialty resins such as silicones, siloxanes, and silanes that penetrate into the concrete and form a chemical barrier to water, oil, and other common contaminants.

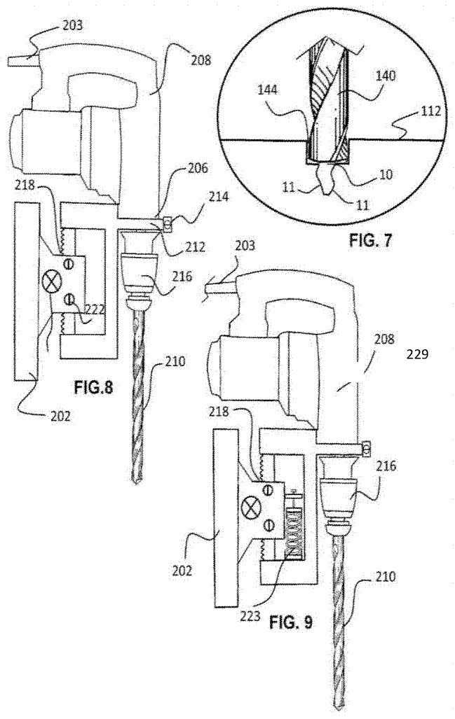

Shown in FIG. 7 is a cross-sectional view where in one embodiment a channel 229 is formed above or over a crack/fissure 11 by a tool.

Shown in FIG. 8 depicts a translating mount 202 which is engaged to a tool 208 which is adapted to roll upon a surface 12 to impart channels thereon. Tools described herein for forming channels may be selected from a group including drills, rotary-hammers, impact drills, jack hammers, grinders, oscillating tools, vibrators, routers, concrete engraving tools, circular saws, granite cutters, and others that are known in the concrete art. In as much as pre-existing cracks/fissures typically have rough and irregular corners, certain tools have been identified as being better suited to creating channels with corners that have similar characteristics. For example, as compared to a circular cutter, in some embodiments, the vertical up down motions of tools and/or their accessories such as impact drills, jack hammers, rotary hammers and other tools having similar functionality have been found to cause chipping of the corners of channels in a manner that better mimics the natural rough irregular appearance of the corners of pre-existing cracks/fissures. In some embodiments, impact drills, jack hammers, rotary hammers, engravers, and routers have been found to be easier to control to create non-linear channels. Mount 202 has an engagement position 206 which is adapted to connect with tool 208. A clamp 212 with compression fixing screw 214 engages around the tool 208 rearward of a chuck 216 which holds a tool accessory 210. This configuration works well with hammer drills, drills, and similar power tools.

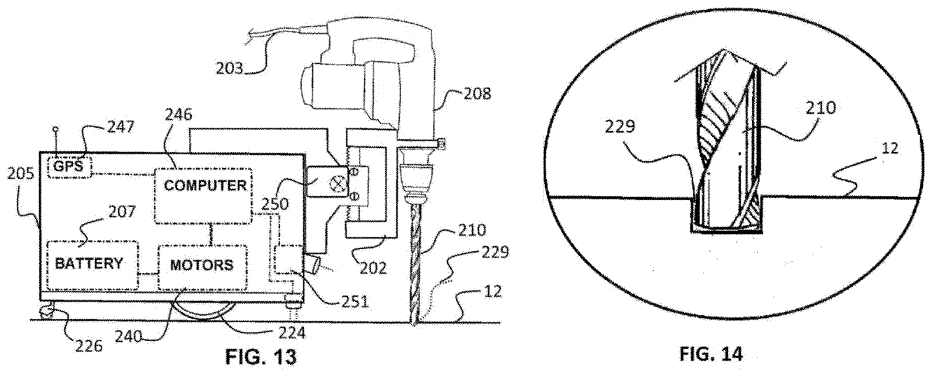

A rack and pinion 218 allows for translation of the distal end of the tool accessory 210 toward and away from the surface 12 to render deeper or shallower channels, and for lifting the distal end of the engraving tool 210 above the surface 12 to move it to another point to be channeled. A drive gear 220 allows for this translation by hand rotation or motorized rotation as in the mode of the system herein in FIG. 13. Locks 22 can be used to fix the position.

FIG. 9 depicts a translating mount 202 that includes a biasing mechanism 223 which will bias the accessory tool 210 into the surface 12 and that allows for the accessory tool to retract if the bias is overcome such as would occur when an obstacle is encountered. The configuration of the mount 202 as in FIGS. 8 and 9, allows the user to employ their own power tool 20 and engage it with the mount, and thereby use the same tool for other purposes. The configuration of the engagement position 206 can be changed to adapted the engagement position 206 for operative engagements with other types of tools. In one embodiment, a control cable 203 may be employed to control rotation and speed of the tool. In another embodiment, a tool may be configured to operate via commands received wirelessly as could be implemented by those skilled in the art. In another embodiment, control buttons (not shown but well known) on the tool 208 itself, can be employed to control the tool.

FIG. 10 depicts a tool 208 that enables a user to create channels in surface 12. As depicted the tool has a pair of wheels 224 located on a side of the tool 204 from which a handle 205 projects. A rotating wheel 226 is located on the end opposite the handle 205. This configuration has been found to be the easiest for a user to employ in forming channels in a surface 12 as it allows the user to view the tool accessory 210 from above while pulling the handle 205 during use.

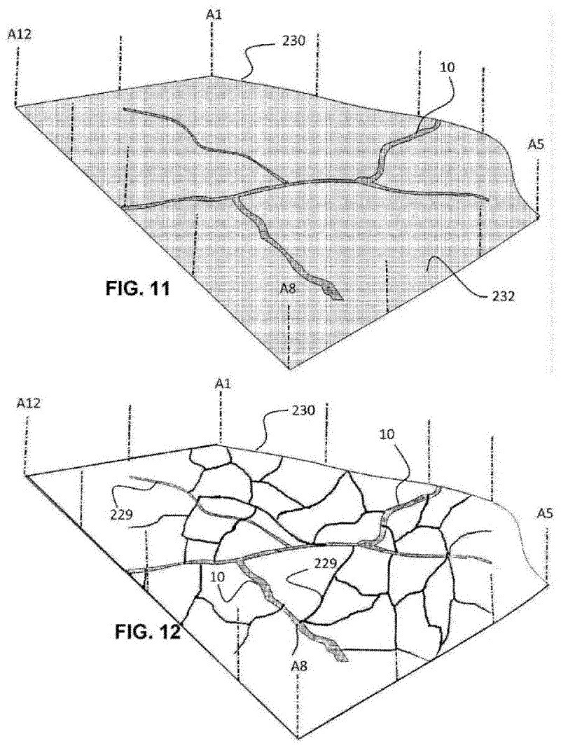

As depicted in FIG. 11, a perimeter 230 of a surface 232 comprised of pre-existing fissures 10 is shown. Although the surface 232 is depicted in a horizontal orientation, the scope of the present invention is also intended to apply to surfaces and fissures formed in vertical surfaces, for example, but not limited to: walls and wainscoting. In one embodiment, pre-existing fissures 10 are located via an optical detector or scanner positioned over the surface. In one embodiment, the optical detector or scanner is used to obtain a 2D or 3D image of the surface, which is subsequently stored in a memory, and data from the image is analyzed by software and processor to determine and store the location of the fissures and/or locations of the perimeter, and/or other features. In embodiments, the optical detector, memory, software, firmware, and/or processor can be implemented as part of a tool used to form channels in the surface, or separately from the tool. In one embodiment, having determined locations of the fissures and/or perimeter, software can be used to determine the locations of one more channel that will subsequently be formed in the surface. In one embodiment, the location and other information can be displayed on a monitor. In one embodiment, channel locations may be determined using the location of the pre-existing fissures and/or perimeter as reference points. In one embodiment, having determined the desired location of the one or more channel, the desired location is used to move the tool over the surface along a path to form the one or more channel. In one embodiment, the desired location of the channels is determined in a manner such that the surface will no longer be comprised of only pre-existing fissures, but as well subsequently formed channels that complement the fissures to give the overall appearance of the surface a more aesthetic look and feel. In one embodiment, the tool is driven according to GPS coordinates of features determined at the time an image of the surface is obtained. In one embodiment, the software is used to generate a guide that can be implemented optically or as a separately implemented template having a pattern corresponding to channel locations and that can be overlaid over the surface, where the guide can be subsequently followed by the tool in an automated or manual manner. In one embodiment, a guide for the channels can be manually created by a user, for example, as a plurality of lines that are drawn on the surface and that extend from the pre-existing fissures, which lines can be used by the user to manually drive the tool along the lines to form the channels.

As depicted in FIG. 12, a surface comprised of pre-existing fissures 10 and channels 229 as described with reference to FIG. 11 is shown. Using an image, guide, software, processor, and/or other means as described above, an actual or virtual guide may be used to direct a tool to create channels 229 in surface 230.

In one embodiment, once a desired position of channels 229 is determined, a guide may be formed to guide a tool, for example tool 208 in FIG. 10. In a manual mode, the tool may be driven according to directions provided by the guide. In one embodiment, a guide can be provided upon the surface by projecting an image of comprised of lines that represent positions of channels to be formed.

In one embodiment shown in FIG. 13, a mount 202 is engaged with a tool 208 and a tool accessory 210 of choice is engaged with a self-propelled tool 205. As shown the self-propelled tool 205 has wheels 224 which are operatively engaged with electric motors 240 that are configured to propel the tool 205 in any direction along surface 12 by following a guide held in a memory of computing device 246, where the guide is representative of channels 229 to be formed. Positioning of the tool accessory 210 upon the surface to impart the channels according to the guide is handled by motors 240 which are controlled by the computer 246. In embodiments, a tool accessory may comprise a drill, a grinder, an impactor, a cutter, a bit, a saw or other accessory compatible for use with a tool 205 and capable of creating additional channels on a cracked surface.

Self-propelled tool 205 can start from a known position upon the surface 12 which may either be input to the computer 246, or determined using an electronic location sensor such as a GPS receiver 247 communicating the terrestrial position of the tool 205 to the computer 246 which will use that information to drive the tool 205 using the motor or motors 240 on the surface. This mode of the method and device herein, like the others will allow the user to mount an existing tool 208 on the mount 202. As shown in FIG. 13, mount 202 may have an electric motor 250 rotating drive gear 220 of rack and pinion 218 to cause the distal end of tool accessory 210 to move deeper and shallower into the surface 12, and to raise above the surface 12 when changing positions. Rack and pinion 218 may allow translational positioning of the tool accessory.

It should be noted that while the method and apparatus herein is described for imparting channels 229 in a surface that is generally horizontal, it could be employed to impart indicia into vertically disposed surfaces, for example, using a tool 204 or 205 which is supported to move in a vertical orientation, or, by positioning a moveable arm (not shown) in between the tool 204 or 205 and the mount 202. Where a computerized system is employed similar to that of FIG. 13, a robotic arm (not shown) could be engaged between the self-propelled tool 205 and the mount 202, and thereby move the mount 202 vertically while controlling the translation of the tool accessory 210. In this fashion indicia can be imparted to vertically disposed stone and cementitious surfaces.

The present subject matter is not limited to the specific methods stated above. Other options for creating an appearance of authentic set-stone on a surface may use selected subsets of the steps described above. Preference and budget will dictate which steps should be used. Areas of high visibility will be most appealing and authentic if more steps are performed.

In another method a user may: 1. Grind or scarify surface where necessary for evenness and safety; 2. Create channels in and/or over existing cracks/fissures if desired; and if not, then create control joint channels to limit and direct future cracking; 3. Place stop channels, cardboard furring strips, foam (or other material that can be removed easily after overlay and texturing procedure); 4. Prepare surface using recommended materials for optimal performance of overlay material; 5. Apply overlay and stamp or texture which may be tinted with coloring; 6. Apply colors to desired result; 7. Apply sealer to protect color work from being clouded by grout material. This makes for easier cleanup after grouting; 8. Outline desired patterns to be turned into channels. This can be accomplished by scoring lines, chalking, taping, or other; 9. Use a power tool to create complimentary additional channels that may be grouted; 10. Apply grout and use typical grout-cleanup methods commonly used; 11. After grout is cured, another coat of sealer is applied.

In a more basic method than described above, the user may: 1. Grind or scarify a cracked surface if necessary for evenness and safety; 2. Apply color to surface for desired result; 3. Apply sealer to protect color work from being clouded by grout material; 4. Instead of creating deep channels with invention, use at shallow depth to create the appearance of grout rather than actually applying grout; 5. Further, when rendering indicia into the surface which is a photo or drawing or the like, the channels may simply be made as small dot-like channels formed into the surface that when viewed from afar appear as the intended photo image or drawing.

In another method: a) a position of preexisting fissures is determined upon the surface; b) placement positions for channels is determined that in combination with the fissures will form the desired image or indicia into the surface; d) a guide is employed to impart the channels according to the placement positions on the surface using a powered tool to form the channels in the placement positions; e) and if desired, the original fissures and/or channels may be filled with filler material.

In employing the guide to impart channels to the surface, the user may use a wheeled tool to pull the powdered tool, or if a robotic tool is employed, a computer navigation system on the tool will drive and steer the tool, to form the channels using the guide which is stored in electronic memory.

While all of the fundamental characteristics and features of the surface repair and remediation system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful device and system herein disclosed, that various substitutions, modifications, and variations may occur to and be made by those skilled in the art, without departing from the spirit or scope of the invention. Further, the accompanying drawings, which are incorporated herein and form a part of the specification, illustrate some, but not the only or exclusive examples of embodiments and/or features of the invention. It is intended that the embodiments and figures disclosed herein are to be considered illustrative, rather than limiting. Consequently, all such modifications and variations and substitutions, as would occur to those skilled in the art are considered included within the scope of the invention as defined by the following claims.

1. A method of rehabilitating and beautifying a surface of a body having one or more pre-existing crack by adding a plurality of channels to the surface, the method comprising the steps of:
(a) supporting a tool over the surface; and
(b) directing the tool against the surface to create the plurality of channels in the surface, wherein the plurality of channels are each defined by two opposite ends and a length, wherein the length is longer than a measured straight-line distance between the two opposite ends.

2. The method of claim 1, wherein the length is at least 5% longer than a measured straight-line distance between the two ends.

3. The method of claim 1, wherein at least one of the plurality of channels is non-linear over its entire length.

4. The method of claim 1, wherein the one or more pre-existing crack and the one or more plurality of channels define a border of one or more shape.

5. The method of claim 4, wherein at least two shapes share a portion of the same border.

6. The method of claim 1, wherein at least one of the plurality of channels extends from at least one of the one or more crack at angle that not is 90 degrees.

7. The method of claim 1, wherein the plurality of channels are defined by a maximum depth, and wherein the maximum depth is one inch or less.

8. The method of claim 1, wherein the plurality of channels are configured to function as a control joint.

9. The method of claim 1, wherein the step of directing the tool comprises repeatedly directing the tool vertically up and down against the surface while also directing the tool horizontally over the surface.

10. The method of claim 9, wherein the tool is selected from the group consisting of: an impact drill, a jack hammer, engraver, and a rotary hammer.

11. The method of claim 1, further comprising a step of positioning a guide onto the surface.

12. The method of claim 11, further comprising the steps of: determining a position of the one or more pre-existing crack; and directing the tool based on the step of determining the position.

13. The method of claim 12, wherein the guide is comprised of one or more line.

14. The method of claim 13, wherein the one or more line is formed by a projected image.

15. The method of claim 14, wherein the step of directing comprises directing the tool along the one or more line.

16. The method of claim 9, further comprising the steps of: detecting a position of the guide;
generating an electronic signal based on the position of the guide; and directing the tool along the surface according to the electronic signal.

17. The method of claim 16, wherein the electronic signal is processed by a computer prior to the step of directing the tool along the surface.

18. The method of claim 1, further comprising the steps of providing a motorized platform and using the motorized platform to direct the tool along the surface.

19. The method of claim 1, wherein the concrete body comprises a driveway, patio, sidewalk, wall, walkway, floor, and/or a foyer.

20. The method of claim 1, further comprising the steps of: applying a material to the surface, and filling the plurality of channels and the one or more pre-existing crack with the material.

21. The method of claim 1, wherein the body is selected from the group consisting of: concrete, stone, and tile
